(19) United States
(12) Patent Application Publication
(10) Pub. No.: US 2013/0072171 A1
(43) Pub. Date: Mar. 21, 2013

(54) ENHANCING MOBILE DEVICE COVERAGE

(71) Applicants: Ajay Sahai, Cupertino, CA (US); John K. Thomas, Saratoga, CA (US)

(72) Inventors: Ajay Sahai, Cupertino, CA (US); John K. Thomas, Saratoga, CA (US)

(73) Assignee: RAMBUS INC., Sunnyvale, CA (US)

(21) Appl. No.: 13/615,257

(22) Filed: Sep. 13, 2012

Related U.S. Application Data
(60) Provisional application No. 61/535,934, filed on Sep. 16, 2011.

(51) Int. Cl. H04W 4/16

(52) U.S. Cl. 455/417

(57) ABSTRACT

Embodiments of methods, apparatuses and systems for operating a mobile device are disclosed. One method includes receiving at the mobile device, a call initiated by an endpoint device. Upon determining that an identifier of the call is not associated with at least one preferred operating center, the call is redirected to the at least one preferred operating center. After the redirecting, the redirected call is received by the mobile device from the at least one preferred operating center.

This application claims priority to U.S. provisional application Ser. No. 61/535,934, entitled “ENHANCING MOBILE DEVICE COVERAGE”, filed Sep. 16, 2011 which is hereby incorporated by reference as if set forth in full in the application for all purposes.

### TECHNICAL FIELD

The subject matter disclosed herein generally relates to enhancing coverage available to mobile devices.

### BACKGROUND

Customers of wireless service providers are continually demanding improved wireless coverage for their wireless devices. After decades of enhancement and generations of technologies, wireless carriers continue to expend considerable resources to improve coverage and capacity. Despite these efforts, the gaining popularity of smart phones and portable computers is outpacing the ability of wireless carriers to satisfy consumer demand for increased wireless service.

Smart phones and portable computers typically are capable of communicating using multiple different types of wireless communications protocols. In some locations one type of wireless communication protocol can provide a better wireless connection than others. Customers of wireless service providers want the ability to utilize the wireless communication protocol at any given time and location that provides the best wireless connection.

There is a need for methods, apparatuses and systems that support enhanced wireless coverage for mobile devices.

### BRIEF DESCRIPTION OF THE DRAWINGS

The subject matter disclosed is illustrated by way of example, and not by way of limitation, in the figures of the accompanying drawings and in which like reference numerals refer to similar elements and in which:

FIG. 1 shows an embodiment of a wireless network system in which an endpoint device communicates with a mobile device through at least one preferred operating center;

FIG. 2A illustrates a method redirecting a call though at least one preferred operating center according to one embodiment;

FIG. 2B illustrates a method of redirecting a call through at least one preferred operating center, wherein a mobile device include multiple personalities, according to one embodiment;

FIG. 3 illustrates a method for redirecting a call from an endpoint device to a mobile device through at least one preferred operating center according to one embodiment;

FIG. 4 illustrates a method of an operating center receiving a redirected call and forwarding the redirected call to a mobile device according to one embodiment; and

FIGS. 5A and 5B illustrate an embodiment of a wireless device that can be used as a mobile device.

### DETAILED DESCRIPTION

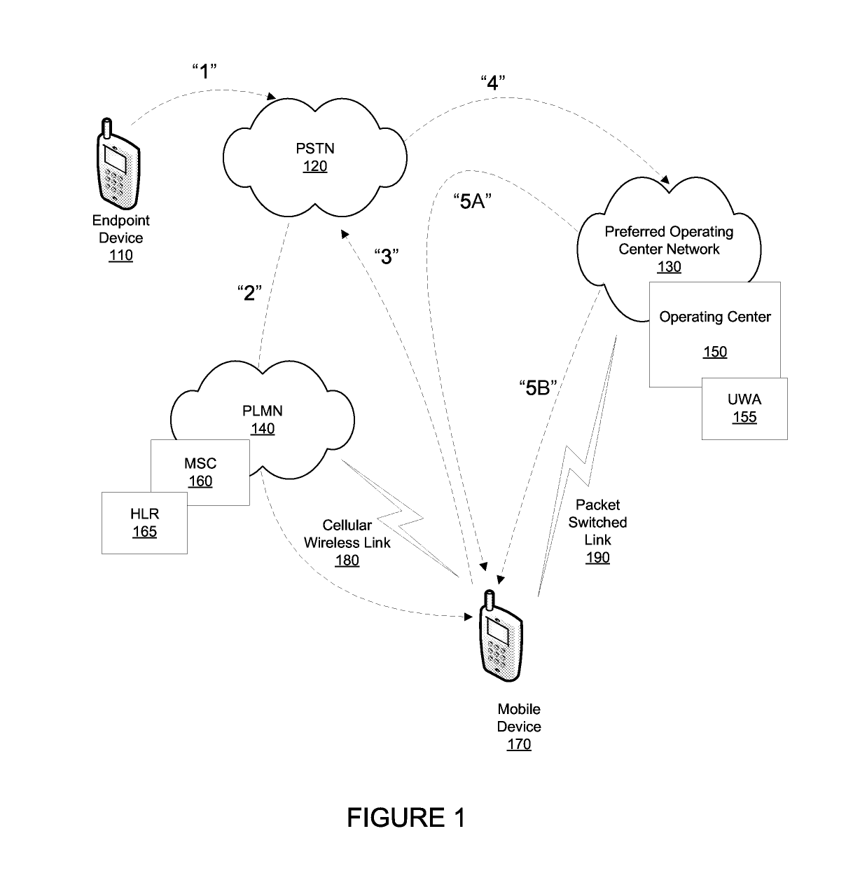

FIG. 1 illustrates an embodiment of a wireless network system in which an endpoint device 110 communicates with a mobile device 170 through at least one preferred operating center 150. According to some embodiments, such communication through the operating center 150 allows the mobile device 170 to roam between a cellular network and an operating center network, and therefore, increases the coverage available to the mobile device 170. The mobile device 170 of FIG. 1 communicates with the cellular network through a cellular wireless link 180, and with the operating center network, for example, through a packet switched link 190.

The cellular wireless link 180 can support voice and data services over a number of access technologies such as, but not limited to, GSM, EDGE, CDMA, W-CDMA, GPRS, WiMax, LTE or other packet-switched protocols. The packet switched link 190 can support voice and data service over a number of packet switched technologies such as, but not limited to, WiFi (802.11).

FIG. 1 depicts a sequence of events that occur to establish the connection of the endpoint device 110 to the mobile device 170 through the preferred operating center 150, according to some embodiments. A first event (depicted in FIG. 1 with a call-leg “1”) includes the endpoint device 110 initiating a call to the mobile device 170 by establishing a connection to, for example, a public switched telephone network (PSTN) 120. The endpoint device 110 is shown in FIG. 1 as a mobile device. However, in some embodiments, the endpoint device can be any device that is attached to a communications network with the capability of originating a call. In the embodiment shown in FIG. 1, the communications network used by endpoint device 110 to originate a call to mobile device 170 includes PSTN 120 which routes (depicted in FIG. 1 with a call-leg “2”) the call to the (destination) mobile device 170 through a public land mobile network (PLMN) 140. The portions of the call labeled 1, 2, 3, 4, 5A and 5B in FIG. 1 are referred to as “call-legs”. Collectively, the call-legs define a call between, for example, the endpoint device 110 and the mobile device 170.

Generally speaking, the PLMN 140 represents a network that is established and operated for the specific purpose of mobile telecommunications services. Each operator providing cellular services typically has its own PLMN. PLMNs interconnect with other PLMNs and PSTNs for telephone communications or with internet service providers for data and internet access of which links are defined as interconnect links between providers. While the PSTN 120 of FIG. 1 utilizes the PLMN 140, it is to be understood that other embodiments includes the utilization of other types of networks and services.

The endpoint device 110 initiates a call to the mobile device 170 by dialing a telephone number associated with the mobile device 170. The call is routed (through the PSTN 120 and PLMN 140) to a mobile switch center (MSC) 160. For the embodiment shown in FIG. 1, the MSC 160 provides an entrance from the PSTN 140 to a mobile provider's network. Other embodiments of the MSC 160 are based, for example, on an IP Multimedia Subsystem (IMS) architecture. MSC 160 determines a current location of the mobile device 170 in order to connect the call. The MSC 160 does this by consulting a home resource register (HLR) 165 which knows which visitor location register (VLR, not shown) the mobile device is associated with. After the mobile device 170 is paged, the call is delivered to the mobile device 170.

While the embodiment shown in FIG. 1 includes the endpoint device 110 being connected to the PLMN 140 through the PSTN 120, it is to be understood that other embodiments include the endpoint device 110 being connected directly to the PLMN 140. That is, for example, the endpoint device 110 could be a subscriber of a provider who manages the PLMN 140. If the mobile device 170 is a subscriber of the same PLMN provider, then the PSTN 120 would not have to be involved in an initial call connection between the endpoint device 110 and the mobile device 170.

The mobile device 170 receives the call, and determines whether the received call has been redirected (that is, a routing path between the source of the call and the destination has been updated by, for example, the MSC) through the preferred operating center network 130. The mobile device 170 makes this determination by checking whether an identifier of the call is associated with the preferred operating center 150. If the identifier indicates that the call has not already been redirected through the preferred operating center 150, the mobile device 170 redirects the call through the preferred operating center 150. Embodiments of the mobile device 170 redirecting the call through the preferred operating center include the mobile device 170 responding to the received call with, for example, a call forward no answer (CFNA). The CFNA forwards the call, for example, to the PSTN 120 through the PLMN 140 (designated in FIG. 1 by the call-leg “3”).

In example embodiments, when a call is being redirected through the preferred operating center 150, an identifier associated with the call is updated by the operating center 150 to indicate that the call has been redirected through the preferred operating center 150. As stated, the mobile device 170 determines whether a call has been redirected through the preferred operating center 150 by this identifier.

The PSTN 120 then routes the call (designated in FIG. 1 with a call-leg “4”) to the preferred operating center network 130. The preferred operating center network 130 includes the preferred operating center 150. Based upon information associated with the call-leg “4” the preferred operating center 150 establishes a call back to the mobile device 170 either through the PLMN 140 (designated in FIG. 1 with a call-leg “5A”) or directly to the mobile device 170 from the preferred operating center network 130 (designated in FIG. 1 with a call-leg “5B”). That is, the final call-leg (5A or 5B) is delivered to the mobile device 170 through either the cellular wireless link 170 or through the packet switched link 190 as determined by the operating center 150.

Embodiments include the operating center 150 establishing a logical communications path to the mobile device 170. The logical communications path can be formed through either the cellular wireless link 180 or packet switched link 190. Generally, one of four conditions can exist. For a first condition, the logical communication path cannot exist because the mobile device 170 is not in communication range with either the cellular wireless link 180 or the packet switched link 190. For a second condition, the mobile device 170 is in communication range with the cellular wireless link 180 but not the packet switched link 190, and the logical connection exists over the cellular wireless link 180. For a third condition, the mobile device 170 is in communication range with the packet switched link 190 but not the cellular wireless link 180, and the logical connection exists over the packet switched link 190. For a fourth condition, the mobile device 170 is in communication range with the cellular wireless link 180 and the packet switched link 190, and the logical connection exists over the cellular wireless link 180 and/or the packet switched link 190. For the first condition, the operating center 150 does not know how that mobile device 170 can be reached for delivering a call-leg. For each of the other conditions, the operating center 150 can determine which call-leg to establish based on where the mobile device is located and how it can be reached. The logical communications path provides a method for conveying information between the mobile device 170 and the operating center 150. The information includes, for example, a caller identification of an endpoint device 110.

As stated, the logical communications path exists between the mobile device 170 and the operating center 150. For embodiments, the logical communications path is established either when a controlling application is invoked, when mobile device 170 is powered, or when a profile of the mobile device 170 is changed. For embodiments, the logical communications path is based on an IP protocol using any one of typical underlying radio technologies, such as, but not limited, to GPRS, HSPA, EV-DO, LTE, WiFi, SMS/USSD, WAP and/or DTMF.

In example embodiments, the logical communications path is maintained at all times that the embodiments for redirecting calls through the operating center 150 are being utilized. In addition to providing the ability to continue calls uninterrupted as the mobile device 170 physically moves across the boundaries of the multiple network connections, embodiments of services provided by the operating center 170 further may include features, such as, an online address book/directory lookup, and presence information. For other embodiments, the logical communications path can be used for communicating call control information. For example, call control information can be used to communicate a handoff request from between one of the cellular wireless link 180 and the packet switched link 190 to the other of the cellular wireless link 180 and the packet switched link 190.

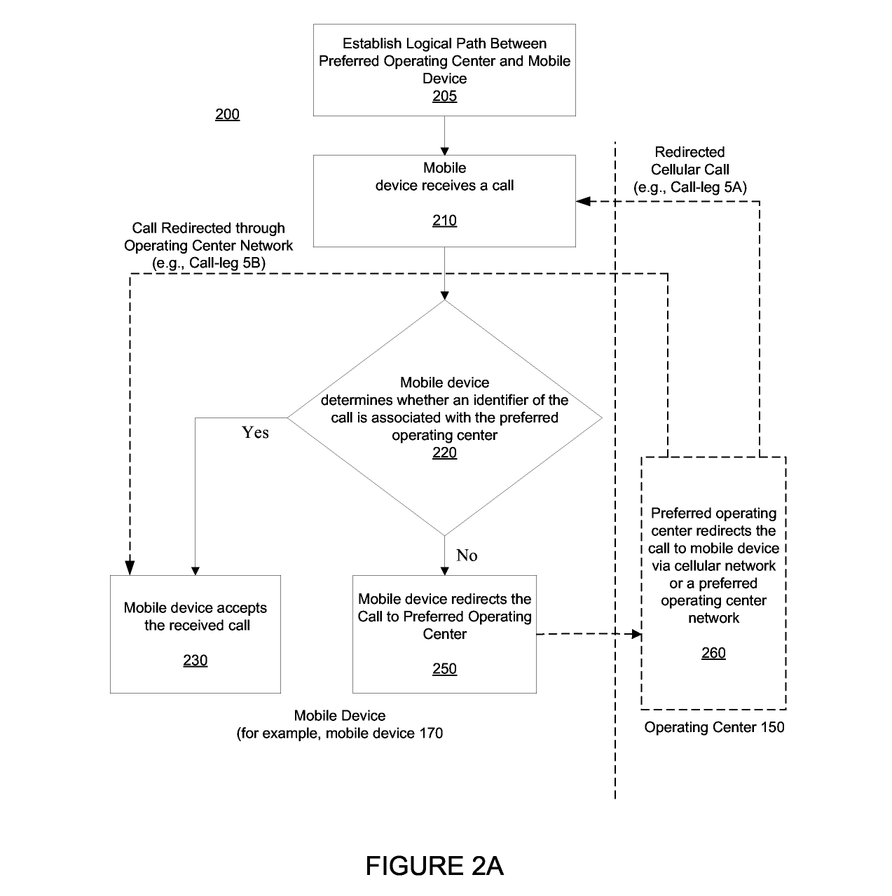

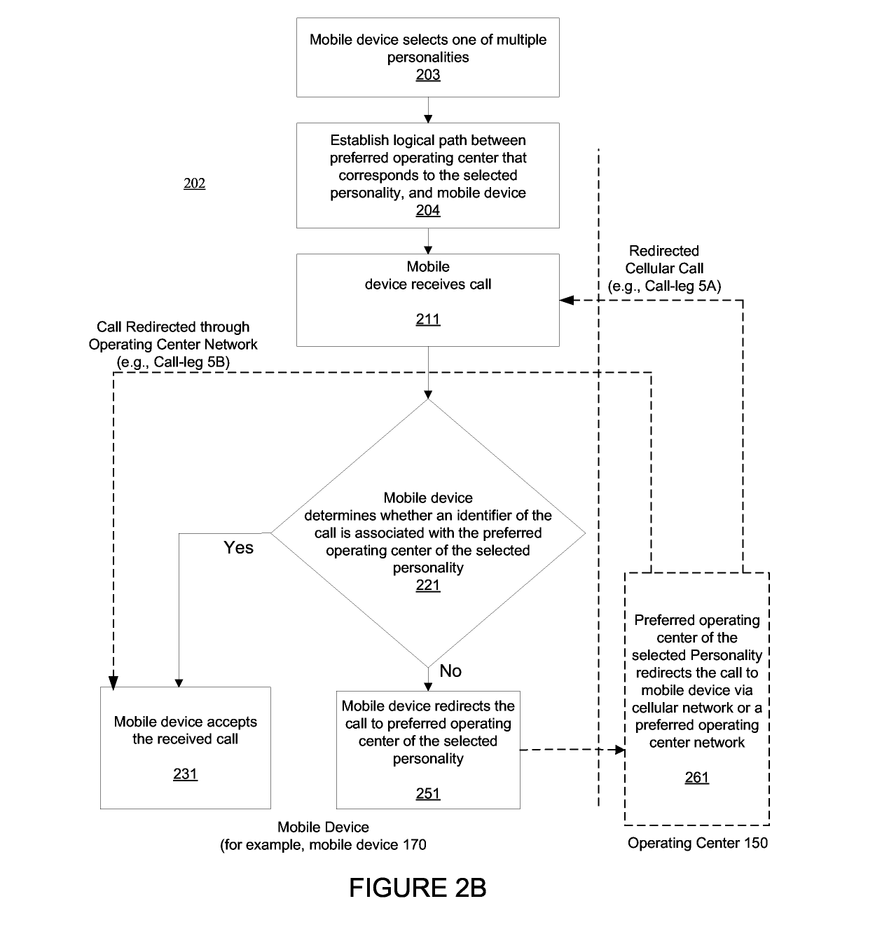

FIG. 2A illustrates a method 200 of a mobile device (e.g., mobile device 170) redirecting a call though at least one preferred operating center according to some embodiments. A logical communications path is established between the mobile device and the at least one preferred operating center (205). The mobile device receives a call from an initiating device, such as endpoint device 110 (210). The mobile device determines whether an identifier of the call is associated with the at least one preferred operating center (220). If the identifier of the call is associated with the at least one preferred operating center, the mobile device accepts the call (230), which includes, for example, alerting the user (for example, ringing the mobile device) and displaying a caller identification of an endpoint device of the call.

If the identifier of the call is not associated with the at least one preferred operating center, the mobile device redirects the call to at least one preferred operating center (250). The preferred operating center 150 includes identifier information with the call, and redirects the call to the mobile device (e.g., mobile device 170) through either a cellular network or a preferred operating center network as determined based on information received from the mobile device (260). For one embodiment, the information is received by the preferred operating center from the mobile device through the logical path.

In one embodiment, determining the identifier of the call and the redirecting of the call to the at least one preferred operating center is managed at an application layer of the mobile device. In another embodiment, determining the identifier of the call and the redirecting of the call is managed at a telephony layer of the mobile device. Managing at the telephony layer may enable the mobile device to indicate a wireless connection quality of at least one of a cellular connection and an alternate wireless connection, to the at least one preferred operating center. This indication of the wireless connection quality can be utilized by the mobile device to instruct the preferred operating center to send the redirected call through the cellular connection or the alternate wireless (packet switched link) connection). In other embodiments, the preferred operating center (instead of the mobile device) makes said determination, based at least in part on the indication of wireless connection quality received from the mobile device.

FIG. 2B illustrates another method (202) of a mobile device (e.g., mobile device 170) redirecting a call though at least one preferred operating center according to one embodiment. FIG. 2B is similar to FIG. 2A, except in FIG. 2B, the mobile device has multiple personalities (or domains) such that one or more of the multiple personalities may be active at a given time and set policies for redirection of received calls. In this embodiment, the mobile device has multiple personalities, for example, a work personality and a personal (for example, home) personality. For example, when functioning as a “work” device, the mobile device may redirect all calls through a work associated operating center. The mobile device may function as a “work” device based e.g., in geographic zones, time zones, etc. When functioning as other personality types, the mobile device may selectively send some calls through the operating center and accept other calls directly. For example, the user's device may be configured with a list of personal or work contact numbers. Contact numbers within or outside this range can be handled one way or the other.

Referring to FIG. 2B, the mobile device selects one of multiple personalities (203) as described above. A logical communications path is then established between the mobile device and the preferred operating center that corresponds with the selected personality (204).

The mobile device receives a call from an initiating device, such as endpoint device 110 (211). The mobile device determines whether an identifier of the call is associated with the preferred operating center of the selected personality (221). If the identifier of the call is associated with the preferred operating center of the selected personality, the mobile device accepts the call (231), which includes, for example, alerting the user (for example, ringing the mobile device) and displaying a caller identification of an endpoint device of the call.

If the identifier of the call is not associated with the at least one preferred operating center, the mobile device redirects the call to the preferred operating center of the selected personality (251). The preferred operating center 150 includes identifier information with the call, and redirects the call to the mobile device (e.g., mobile device 170) through either a cellular network or a preferred operating center network as determined based on information received from the mobile device (261).

In one embodiment, the mobile device can redirect the call to one or more preferred operating centers. For example, one operating center may be associated with a home location of the user of the mobile device, and another operating center may be associated with a work location of the user of the mobile device. Correspondingly, the embodiment includes the mobile device redirecting the call to one of a plurality of preferred operating centers depending upon a location of the mobile device. This embodiment further enhances the coverage provided to the user of the mobile device. For example, this embodiment can be used to provide a WiFi connection to the mobile device at a user's work location, and at a user's home location. As the user of the mobile device physically moves from cellular coverage to a home or work location, a handover form the cellular network to the WiFi connection at the user's home or work locations can be realized.

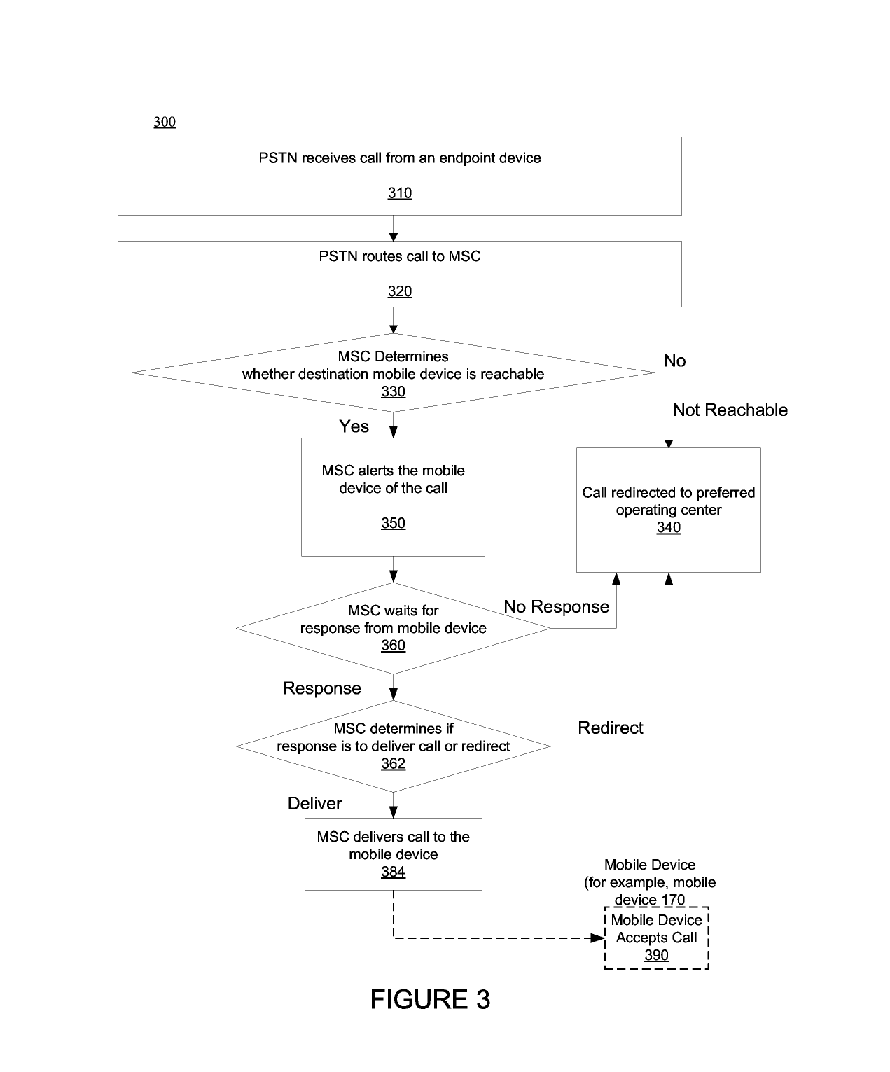

FIG. 3 illustrates a method 300 of redirecting a call from an endpoint device to a mobile device (for example, mobile device 170) through at least one preferred operating center according to an embodiment. Upon origination of a call from an endpoint device, PSTN receives a call from an endpoint device (310) and routes the call to an MSC (320). The MSC determines whether the mobile device is reachable or not (330). If the mobile device is not reachable the call is redirected by the MSC to a preferred operating center (340).

In some embodiments, the determination at (330) is made by utilizing a call forward not reachable (CFNR). The not reachable response is naturally generated if the mobile device is not reachable, for example, through the cellular wireless connection, indicating that the mobile device is out of range of the cellular wireless network. In some embodiments, the CFNR allows the PLMN (MSC) as instructed by users to redirect incoming calls to a mobile or other phone number (configurable destination by user or administrator) when the user's device is unreachable or unregistered (for example, power or connectivity is lost.) This service is automatically activated when the device associated with the called user is not accessible, and the service redirects the call to the specified forwarding destination.

If the mobile device is reachable, the MSC alerts the mobile device of the call (350). The MSC then waits for a response from the mobile device (360). For an embodiment, the MSC times-out if a response is not received by the MSC within a set period of time. If a response is not received (MSC times-out), the call is redirected by the MSC to the preferred operating center (340). If a response is received, the MSC determines whether the response received from the mobile device includes instruction to deliver that call to the mobile device, or to redirect the call to the preferred operating center (362). If the call is to be delivered, the MSC delivers the call to the mobile device (384), and the mobile device accepts the call (390). If the call is to be redirected, the call is redirected to the preferred operating center (340).

In some embodiments, the instructions by the mobile device to redirect the call include the mobile device responding with a call forward not answering (cfna or CFNA) or a call forward busy. CFNA permits a called subscriber (for example, the mobile device) to have the system send incoming calls addressed to the called subscriber's public identity to another public identity (forward-to identity) or to the called subscriber's designated voice mailbox, when the subscriber fails to answer, or is otherwise inaccessible (for example, the subscriber chooses to ignore an incoming call). CFNA does not apply when the subscriber is considered to be busy. CFNA does not impact a subscriber's ability to originate calls. A subscriber may select a forward-to identity termination address when the subscriber registers the CFNA.

Alternatively, in some embodiments the mobile device generates a call forward busy (cfb or CFB). CFB is a service that enables incoming calls that encounter a busy condition, after a programmed interval, be automatically forwarded to another local or long distance phone number where network facilities permit. CFB does not impact a subscriber's ability to originate calls. Rather, a subscriber may select a forward-to number termination address when the subscriber registers the CFB.

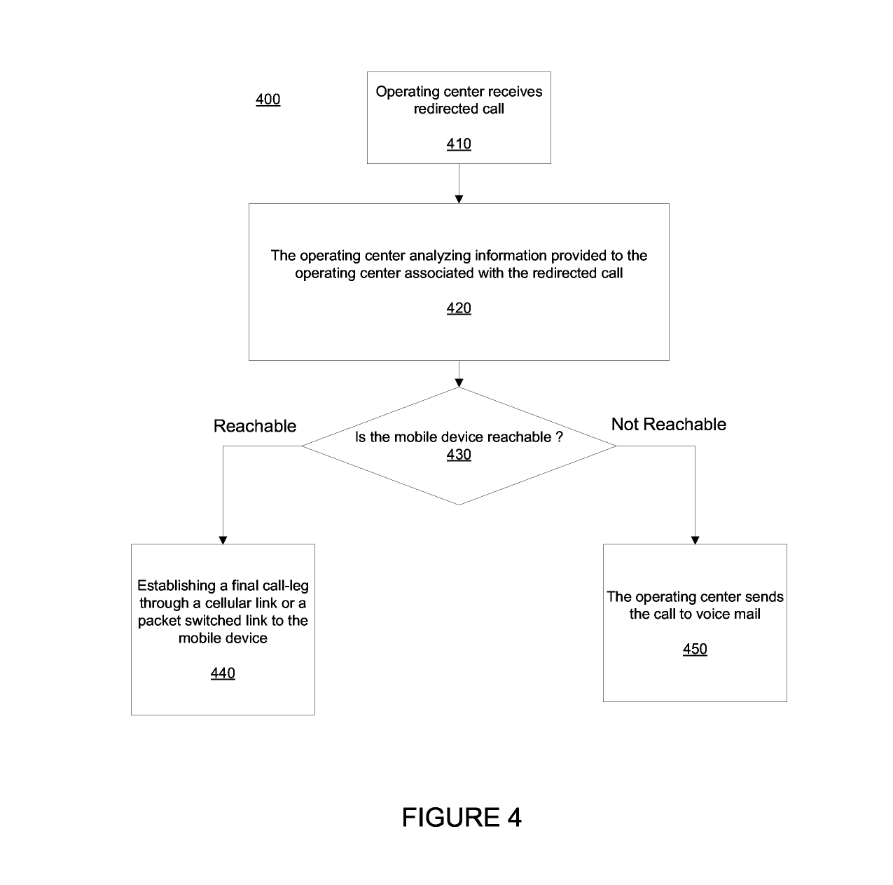

FIG. 4 illustrates a method 400 according to which an operating center receives an incoming call for a (destination) mobile device (e.g., mobile device 170) according to an embodiment. The operating center receives a redirected call (410). The operating center analyzes information provided to the operating center associated with the redirected call (420). This information includes, for example, information received by the operating center through the logical path, such as, whether the mobile device is in receiving range of cellular wireless link, the packet switched link, or neither (this can be determined, for example, through the absence of a logical path). The operating center determines whether the mobile device is reachable or not reachable (430). As previously described, the operating center determines whether the logical communication path is available or not, and if available, which links (cellular and/or packet switched) are available. If reachable, the operating center establishes final call-leg (such as, call-legs 5A or 5B shown in FIG. 1) through e.g., a cellular link or a packet switched link to the mobile device (440). If the user chooses not to answer or if the mobile device is not reachable, the operating center may send the call to voice mail (450). In some embodiments, the operating center provides or signals for (depending on interconnecting trunk type between network and center) call progress tones to the initiating endpoint device 110. The call progress tones include, for example, a calling tone, a busy signal or voice mail. Once mobile device 170 responds to the final call-leg (such as previously described call-legs 5A or 5B) initiated by the operating center, communication between the endpoint device 170 and the mobile device 110 is allowed to proceed.

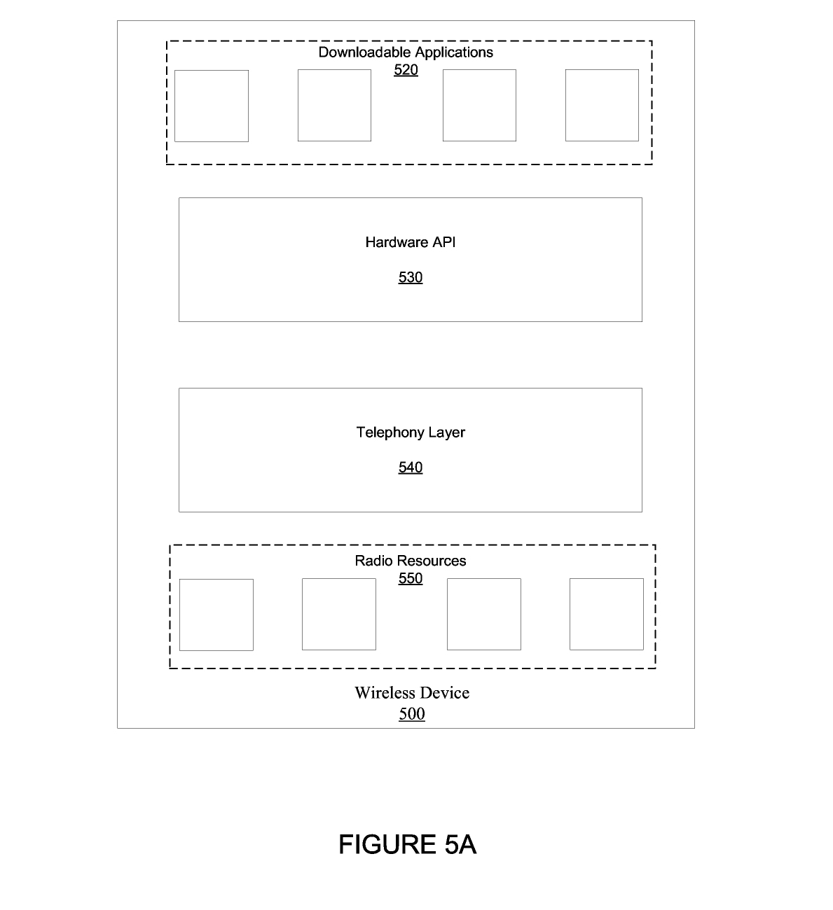

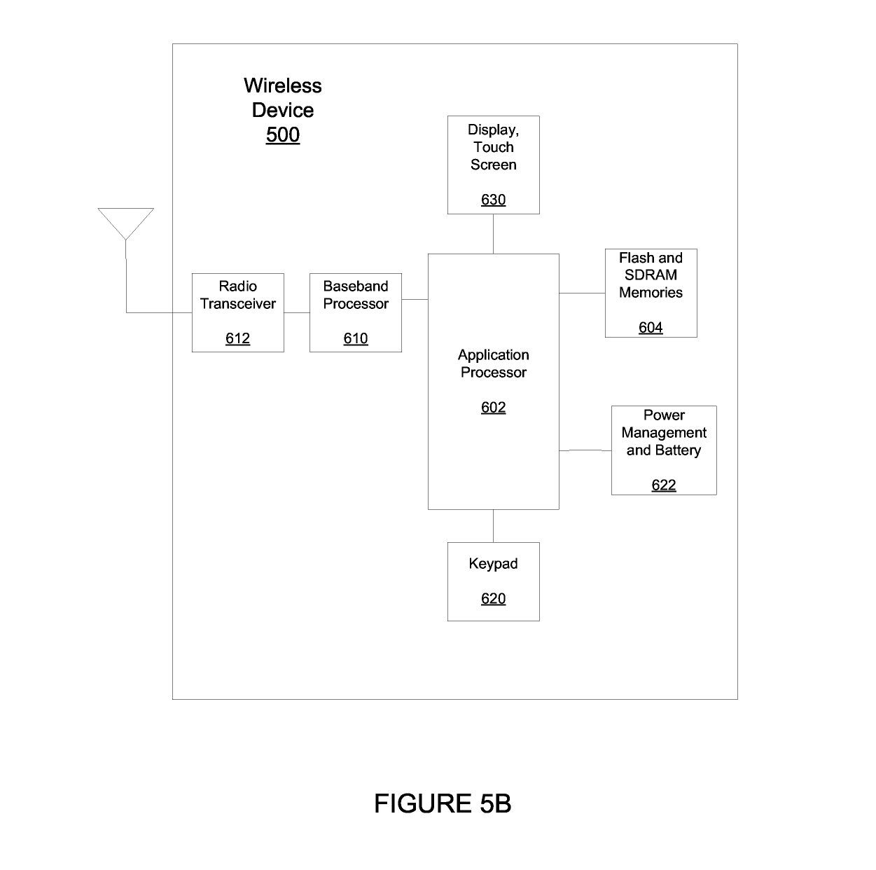

FIGS. 5A and 5B illustrate an embodiment of a wireless device 500, such as one that can be employed as mobile device 170. FIG. 5A illustrates functional portions of wireless device 500, while FIG. 5B illustrates hardware components of wireless device 500.

As depicted in FIG. 5B, functional portions may include: a downloadable applications layer 520, a hardware application programming interface (API) layer 530, a telephony layer 540, and a radio resources layer 550.

In one embodiment, instructions executable by a controller of the mobile device that cause the mobile device to perform the described embodiments of redirecting calls through the at least one preferred operating system, are stored within the downloadable applications layer 520. The instructions can be obtained by the mobile device as a downloadable application. This embodiment can be useful because the instructions can be easily obtained and updated. However, applications within the downloadable applications layer do not have access to radio resources, and therefore, can be limited in their capabilities.

In another embodiment, the instructions executable by the controller of the mobile device that cause the mobile device to perform the described embodiments of redirecting calls through the at least one preferred operating system, are stored within the telephony layer 540. There can be additional value obtained by storing the instruction at the telephony layer 540 because the instructions are afforded access to the radio resource layer 550. Radio information can be stored in the telephony layer that can be used to monitor signal strength of the links and codec metrics which can be used to determine which of available links is more desirable.

As depicted in FIG. 5B, wireless device 500 includes an application processor 602 that has access to a storage resource 604 in the form of flash and/or SDRAM memory modules that may store the code necessary to implement the operating system as well as the application programs. The application processor 602 ultimately controls the embodiments for redirecting calls through at least one preferred operating center whether the application itself is located at the downloadable application layer or at the telephony dialer layer.

The wireless device 500 may further include a baseband processor 610 and radio transceiver 612 that are operable to establish communications in a 3G, 4G or other suitable type of telecommunications protocol. The depicted wireless device 500 may further include a keypad 620, which may include soft keys, hard keys, or a combination thereof, a display device 630 which can include touch screen functionality. Power management and battery 622 provide power to the wireless device 500. Although the depicted embodiment of wireless device 500 includes a variety of peripheral devices, other implementations, such as a network aware automobile radio, may employ fewer or simpler I/O devices.

While the disclosed embodiments have been described in connection with specific embodiments, variations of these embodiments are also contemplated. For example, the cellular link and preferred operating center link can be implemented with any number of equivalent connection technologies. Some components are shown directly connected to one another while others are shown connected via intermediate components. In each instance the method of interconnection, or “coupling” establishes some desired electrical communication. Such coupling may often be accomplished in many ways using various types of intermediate components or circuits, as understood by those of skill in the art. Therefore, the scope of the appended claims should not be limited to the foregoing description. Only those claims specifically recited “means for” or “step for” should be construed in the manner required under the sixth paragraph of 35USC Section 112.

What is claimed:

1. A method of operating a mobile device, comprising:
at the mobile device,
receiving a call initiated by an endpoint device;
upon determining that an identifier of the call is not associated with at least one preferred operating center, redirecting the call to the at least one preferred operating center; and
after the redirecting, receiving the redirected call from the at least one preferred operating center.

2. The method of claim 1, further comprising establishing a logical communications path between the mobile device and the at least one preferred operating center.

3. The method of claim 2, further comprising the mobile device obtaining at least a caller identification of the endpoint device through the logical communications path.

4. The method of claim 3, further comprising: at the mobile device, upon receiving the redirected call, displaying the caller identification of the endpoint device.

5. The method of claim 1, wherein the redirecting comprises initiating a call forward no answer (cfna).

6. The method of claim 1, wherein receiving the redirected call further comprises: receiving the redirected call from at least one of a cellular network and a preferred operating center network.

7. The method of claim 1, further comprising generating a call forward busy (cfb) or a call forward not reachable (cfnr) response.

8. The method of claim 7, further comprising receiving the redirected call directly from a preferred operating center network if a call forward not reachable response was generated.

9. The method of claim 8, wherein the preferred operating center network comprises a VoIP (voice over internet protocol) infrastructure reachable via an IP wireless connection.

10. The method of claim 1, wherein determining the identifier of the call is performed at a telephony dialer layer of the mobile device.

11. The method of claim 1, further comprising: at the mobile device, indicating a wireless connection quality of at least one of a cellular connection and an alternate wireless connection, to the at least one preferred operating center.

12. The method of claim 11, wherein receiving the redirected call from the at least one preferred operating center comprises: receiving the redirected call through the cellular connection or the alternate wireless connection based at least in part on the wireless connection quality.

13. The method of claim 1, wherein determining the identifier of the call is performed at an application layer of the mobile device.

14. The method of claim 1, wherein the mobile device comprises multiple personalities, and at least one of the multiple personalities controls the mobile device to determine that an identifier of the call is not associated at least one preferred operating center, and redirect the call to the at least one preferred operating center.

15. The method of claim 1, further comprising the mobile device redirecting the call to one of a plurality of preferred operating centers depending upon a location of the mobile device.

16. A method of redirecting a call to a mobile device through at least one preferred operating center, comprising:
receiving a call initiated by an endpoint device;
upon determining that an identifier of the call is not associated with the at least one preferred operating center, redirecting the call to the at least one preferred operating center; and
after the redirecting, the mobile device receiving the redirected call from the at least one preferred operating center.

17. A mobile device, comprising:
a receiver operative to receive a call initiated by an endpoint device;
a controller operative to determine whether an identifier of the call is not associated with at least one preferred operating center, and redirecting the call to at least one preferred operating center if the identifier of the call is not associated at least one preferred operating center; and
the mobile device operative to receive the redirected call.

18. The mobile device of claim 17, further comprising the controller operative to establish a logical communications path between the mobile device and the at least one preferred operating center.

19. The mobile device of claim 18, further comprising the controller operative to obtain at least a caller identification of the endpoint device through the logical communications path.

20. The mobile device of claim 19, wherein upon receiving the redirected call, the mobile device operative to display the caller identification of the endpoint device.

21. The mobile device of claim 17, wherein the controller redirecting the call comprises the controller initiating a call forward no answer (cfna).

22. The mobile device of claim 17, wherein receiving the redirected call further comprises: receiving the redirected call from at least one of a cellular network and a preferred operating center network.

23. The mobile device of claim 17, further comprising the mobile device generating a call forward busy (cfb) or a call forward not reachable (cfnr) response.

24. The mobile device of claim 23, further comprising the mobile device receiving the redirected call directly from a preferred operating center network if a call forward not reachable response was generated.

25. The mobile device of claim 17, wherein a telephony dialer layer of the mobile device is operative to determine the identifier of the call.

26. The mobile device of claim 17, further comprising the mobile device operative to indicate a wireless connection quality of at least one of a cellular connection and an alternate wireless connection to the at least one preferred operating center.

27. The mobile device of claim 26, wherein receiving the redirected call from the at least one preferred operating center comprises: receiving the redirected call through the cellular connection or the alternate wireless connection based at least in part on the wireless connection quality.

28. The mobile device of claim 17, wherein an application layer of the mobile device is operative to determine the identifier of the call.

29. The mobile device of claim 17, wherein the mobile device comprises multiple personalities, and at least one of the multiple personalities controls the mobile device to determine that an identifier of the call is not associated at least one preferred operating center, and the redirect the call to the at least one preferred operating center.

30. The mobile device of claim 17, further comprising the mobile device operative to redirect the call to one of a plurality of preferred operating centers depending upon a location of the mobile device.

31. A program storage device readable by a machine, tangibly embodying a program of instructions executable by the machine to perform a method of a mobile device, comprising:
receiving a call initiated by an endpoint device;
upon determining that an identifier of the call is not associated with at least one preferred operating center, redirecting the call to the at least one preferred operating center; and
after the redirecting, receiving the redirected call from the at least one preferred operating center.

32. The method of claim 31, wherein the program of instruction operate on an application layer of the mobile device.

33. The method of claim 32, wherein the program of instructions are downloadable to the application layer.

34. The method of claim 31, wherein the program of instructions operate on a telephony dialer layer of the mobile device.

35. A wireless system, comprising:
a mobile device operative to receive a call initiated by an endpoint device;
the mobile device operative to redirect the call to the at least one preferred operating center upon determining that an identifier of the call is not associated with at least one preferred operating center; and
the at least one preferred operating center operative to receive the redirected call, and redirect the call back to the mobile device through at least one of a cellular network and a preferred operating center network; and
the mobile device operative to receive the redirected call from the at least one preferred operating center.

36. A method of an operating center redirecting a call, comprising:
the operating center receiving a call redirected from a mobile device; and
based on information associated with the redirected call, the operating center redirecting the call back to the mobile device through at least one of a cellular network and an operating center network.
